(19) United States
(12) Patent Application Publication
(10) Pub. No.: US 2006/0047710 A1
(43) Pub. Date: Mar. 2, 2006

(54) Globalized database system and method for accessing the same

(76) Inventors: Jiong Hu, Shanghai (CN); Hua Pin Shen, Shanghai (CN); Kai Wei, Shanghai (CN)

Correspondence Address: SAMUEL A. KASSATLY LAW OFFICE, 20690 VIEW OAKS WAY, SAN JOSE, CA, 95120, US

(21) Appl. No.: 11/213,146

(22) Filed: Aug. 25, 2005

(30) Foreign Application Priority Data
Aug. 27, 2004 (CN) 200410068290.X

(51) Int. Cl. G06F 17/30

(52) U.S. Cl. 707/201

(57) ABSTRACT

A globalized database method for accessing a globalized database system determines a locale identification from an application. A database stores a globalized database table that comprises a globalized column corresponding to a user query. Each of the globalized columns comprises data values related to different locales. A database access driver intercepts a database query command of the user. Based on the retrieved locale identification, the present method retrieves the locale sensitive data value corresponding to the locale identification from the globalized columns in the globalized database table.

### PRIORITY CLAIM

The present application claims the priority of Chinese patent application, Serial No. 200410068290.X, titled “Globalized Database System and Method for Accessing the Same,” which was filed on Aug. 27, 2004, and which is incorporated herein by reference.

### FIELD OF THE INVENTION

The present invention relates to a globalized database system for managing locale sensitive data and a corresponding method for accessing the locale sensitive data on the globalized database.

### BACKGROUND OF THE INVENTION

When developing globalized applications, especially Web applications, some data sensitive with respect to locale are stored in the database other than in property files. This type of database is a globalized database. Developers need to design extra tables to store these locale-sensitive data and implement specific database access functions to handle them. Since the globalization concern mingles with the core business concerns in this way, a database access code using JDBC (Java DataBase Connectivity) or other frameworks like Hibernate (a type of software product) are more complicated and require more maintenance than conventional database access codes that do not have globalization capability. A locale acts as an identification of a user's preference for a certain local language; the locale can be composed from a regional ID and a language ID.

Currently, developers use application ad hoc solutions for this problem to capture the globalization requirement early in the design stage. For newly developed systems, developers should follow these steps to implement the globalization feature in a conventional database access layer:
a) Design extra tables for multilingual data in the database;
b) Handle and maintain the locale information of the user, typically with a locale parameter in most interfaces; and
c) Write the database (DB) access codes and modify the language specific tables to retrieve the multilingual data.

Developers expend a large effort to generate a globalization data access layer. Once developed, the globalized data access layer is expensive to modify. Furthermore, when a designer wishes to provide globalization features in an existing system, modifying the data storage layer requires a tremendous effort. The newly added localized data in the database causes many changes to the schema of the database table and all the access codes of the database table.

Using a conventional approach, developers typically modify the DB access layer by following these steps:
a) Design extra tables for multilingual data in the database;
b) Obtain the locale information of the user and modify most of the database access interfaces; and
c) Modify the DB access codes and introduce the language specific tables to deal with the multilingual data.
   In many cases, those efforts are equivalent to regenerating the application.

Furthermore, if the source code of the system is unavailable, then the migration is even more difficult. A practical conventional approach is rewriting the views, controllers and models, respectively:
a) Design extra tables for multilingual data in the database;
b) Obtain the locale information of the user and write some code to transfer it from the view part to the DB access code; and
c) Rewrite the DB access codes, which may combine the previous database access operations and the operations on the newly added database tables.
   This approach is similar to making a shell of the existing system, requiring a tremendous effort and engendering poor performance.

What is therefore needed is a globalized database system and method for accessing the same that provides in the data storage layer a way to separate the globalization concern from the core business concerns. The globalized database system provides the developer with a transparent globalization data storage feature and eases development and maintenance work. The need for such a solution has heretofore remained unsatisfied.

### SUMMARY OF THE INVENTION

The present invention satisfies this need, and presents a system, a computer program product, and an associated method (collectively referred to herein as “the system” or “the present system”) for providing a globalized database system and a method for accessing the globalized database. The present system provides a common and reusable solution for managing and accessing multilingual data in a database. The present system separates globalization concerns from core business concerns, thereby freeing developers from the repetitive work necessary for the implementation of the globalization feature in a database access layer.

The present system provides a globalized database system comprising a locale determining system that determines a locale identification from an application. The present system further comprises a database for storing a globalized database table. The globalized database table comprises a globalized column corresponding to a user query. Each of the globalized columns comprises data values related to different locales. The present system comprises a database access driver for intercepting a database query command of the user. Based on the locale identification retrieved from the locale determining system, the present system retrieves the locale sensitive data value that corresponds to the locale identification from the globalized columns in the globalized database table.

To access the globalized database, the present system intercepts a database query command of the user; retrieves a locale identification of a user; and based on the retrieved locale identification, retrieves the locale sensitive data value that corresponds to the locale identification from the globalized column in the globalized database table.

The present system provides a globalized database system that comprises a method to input data constituting the database. The present system further provides a method for generating a globalized database table. This method extracts locale sensitive data from the input data, generates a globalized database table that comprises a globalized column, and places similar data values corresponding to different locales into at least one globalized column for later database query.

The present system uses a globalized database table (GTable) and build-time and run-time locale models to provide a transparent locale sensitive data access mechanism in the database. The present system enables features comprising:
a) When developing a new system enabling globalization features, developers can focus on their core business functions and use normal database access functions to retrieve these multilingual data;
b) The support for the GTable is almost transparent to the client code or the existing database access code;
c) Existing systems require globalization features do not need to change the database access code to accommodate the multilingual data; and
d) As the result of c), the cost of accessing and maintaining the locale sensitive data in the database is reduced, and developers can obtain globalized features in the database storage layer easier and with less effort.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a globalized database system of the present invention can be used;

FIG. 2 comprises FIGS. 2A and 2B and represents a high-level hierarchy of a build-time scenario and a run-time scenario of the globalized database system of the present invention;

FIG. 3 is a diagram describing an internal structure of the GTable according to the globalized database system of FIG. 2;

FIG. 4 is an example describing the implementation of the globalized database system of FIG. 2 based on the tables shown in FIG. 3;

FIG. 5 is a diagram of a run-time locale model of the globalized database system of FIG. 2 in a single JVM (Java Virtual Machine) environment;

FIG. 6 is a diagram describing an example of a run-time locale model of the globalized database system of FIG. 2 in a distributed environment; and

FIG. 7 is a process flowchart illustrating a method of accessing the globalized database system of FIG. 2.

### DETAILED DESCRIPTION OF PREFERRED EMBODIMENTS

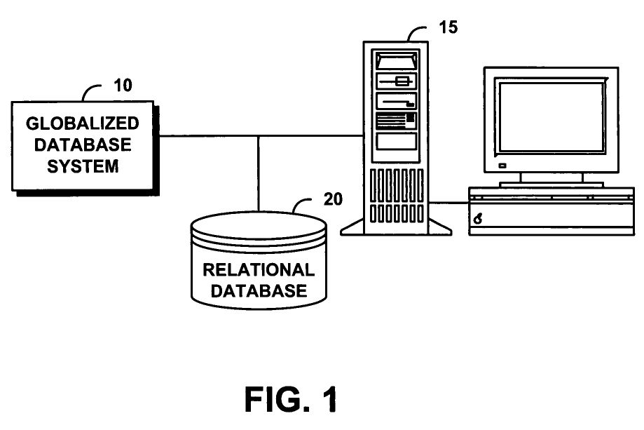

FIG. 1 portrays an exemplary overall environment in which a system, a computer program product, and an associated method (the “system 10”) for a globalized database system and method of accessing the same according to system 10 may be used. System 10 comprises a software programming code or a computer program product that is typically embedded within, or installed on a server 15. Alternatively, system 10 can be saved on a suitable storage medium such as a diskette, a CD, a hard drive, or like devices. System 10 is utilized by a relational database 20 that supports the storage of Unicode encoding such as, for example, UTF-8 in the database. Legacy systems can typically be easily modified to utilize system 10.

System 10 utilizes a globalized table (a GTable) as a database table. The Gtable comprises one or more globalized column(s) (a GColumn). For each GColumn, different localized values corresponding to respective locale can exist in a GTable record. Normal database tables can be changed to the GTable type, and normal non-key columns of a GTable can be transformed into a GColumn type to store locale sensitive data. In an implementation, system 10 provides a globalization database driver that comprises a thin layer upon an existing database driver to support system 10.

In a build-time database locale model concept, a system table is used to record the supported locales in the relational database, and the GTable appears like a conventional database table. Developers can use the same codes to access the conventional database table and the GTables. To achieve this, system 10 obtains the run-time locale of a GTable access operation from a global locale repository rather than directly from parameters in the access codes.

System 10 uses a global locale repository to manage the current locale of each request. Developers register the current locale at a proper place (usually at the beginning of some services). In this way, locale is an environment variable in one process. For distributed systems, other methods are used to propagate locales between different processes. In a GTable access operation, both run-time locale and build-time locale models assist in determining the target of the locale sensitive data.

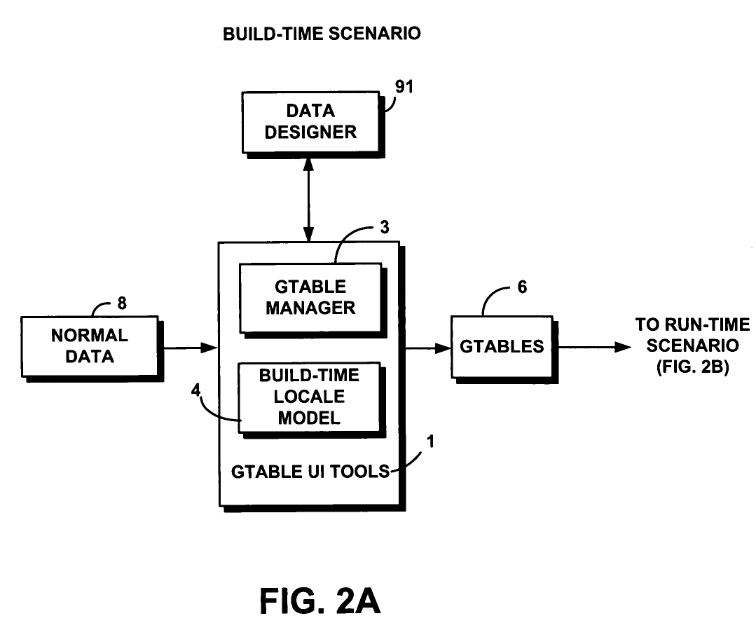

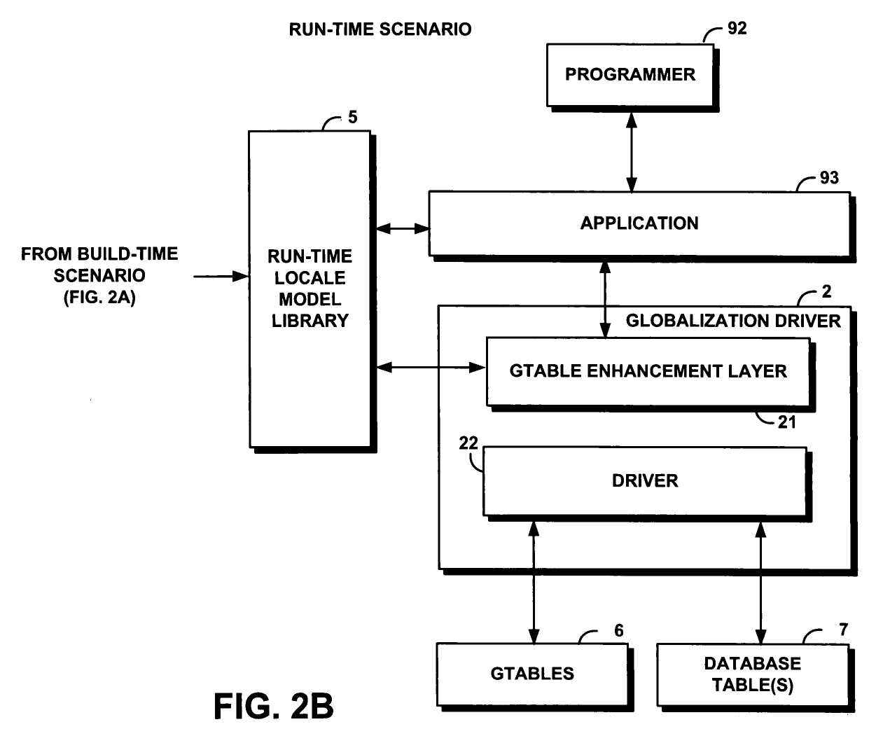

Using the GTable of system 10, build-time and run-time locale models used in the database can be implemented in different platforms using different technologies. In one embodiment, Java technology and DB2 (a kind of database management system software product from IBM corporation) database management system are used. While system 10 is described for illustration purpose only in terms of Java and DB2, it should be clear that the invention is applicable as well to, for example, any object-oriented programming language that is platform independent and any relational database. FIG. 2 shows the overview of system 10 in a build-time scenario and a run-time scenario.

Referring to FIG. 2 (FIGS. 2A, 2 in the build-time scenario a data designer 91 can generate a GTable 6 by using GTable UI (User Interface) tools 1 to design a database mode related to a business application mode. The GTable UI tools 1 generate the globalized database of system 10. The GTable UI tools 1 use a build-time locale model 4 to perform configuration, according to a specific application, on the platform of a GTable manager 3. The GTable UI tools automatically transform normal data 8 requiring incorporation of globalized features into globalized data organized in form of GTable(s) 6) to support a multilingual application. The normal data 8 are usually input into the database through a proper input means (not shown) to form a normal database table. Consequently, the build-time scenario (FIG. 2A) reflects a design point of view.

The run-time scenario (FIG. 2B) reflects an implementation point of view. In the run-time scenario, a programmer (developer) 92 writes a specific application 93. The programmer 92 focuses on the core business functions of the specific application 93, and uses a normal database access function to retrieve multilingual data regardless of the details of the globalized database access; i.e., the globalized database access is transparent to the programmer 92. The globalized database access is implemented by a globalization driver 2 such as, for example, a G11N JDBC driver.

The globalization driver 2 adds a GTable enhancement layer (GTable core) 21 on a normal driver 22. The globalization driver 2 intercepts a query command from the application 93, such as, for example, an SQL query statement, and converts the query command into a form capable of accessing the GTable. While system 10 is described in terms of SQL for illustration purpose only, it should be clear that the invention is applicable as well to, for example, any query language. During the conversion, the GTable enhancement layer 21 incorporates the current locale retrieved from a run-time locale model library 5 into the converted query command (the SQL query statement containing more parameters), and the current locale is registered by the specific application 93 at a proper time (usually at a start time) into the run-time locale model library 5.

The GTable enhancement layer 21 delegates the converted query command to a normal driver 22, thereby accessing directly the underlying database according to the converted query command and retrieving from a GTable 6 the multilingual data to be queried, corresponding to the current locale. For the query command querying database table(s) 7, the GTable enhancement layer 21 does no conversion, and delegates the query directly to the driver 22 so as to access the database table 7. Database table 7 is a normal database table without GTable capability. In FIG. 2, while the GTable 6 and the normal database table 7 are shown as separated database modules for illustration purpose only, it should be clear that these two kinds of data can also be stored in a same database. The run-time locale model library 5 in FIG. 2 determines locales from a variety of applications, and can store locales so as to retrieve the desired locales when globalization driver 2 converts a SQL query statement.

For the programmer 92, system 10 provides a globalization driver 2. The programmer 92 transparently obtains the features that Gtable 6 provides. System 10 provides a thin layer upon the existing driver 22 to enable the concept of the GTable 6. For example, one embodiment uses a DB2 JDBC driver as the driver 22.

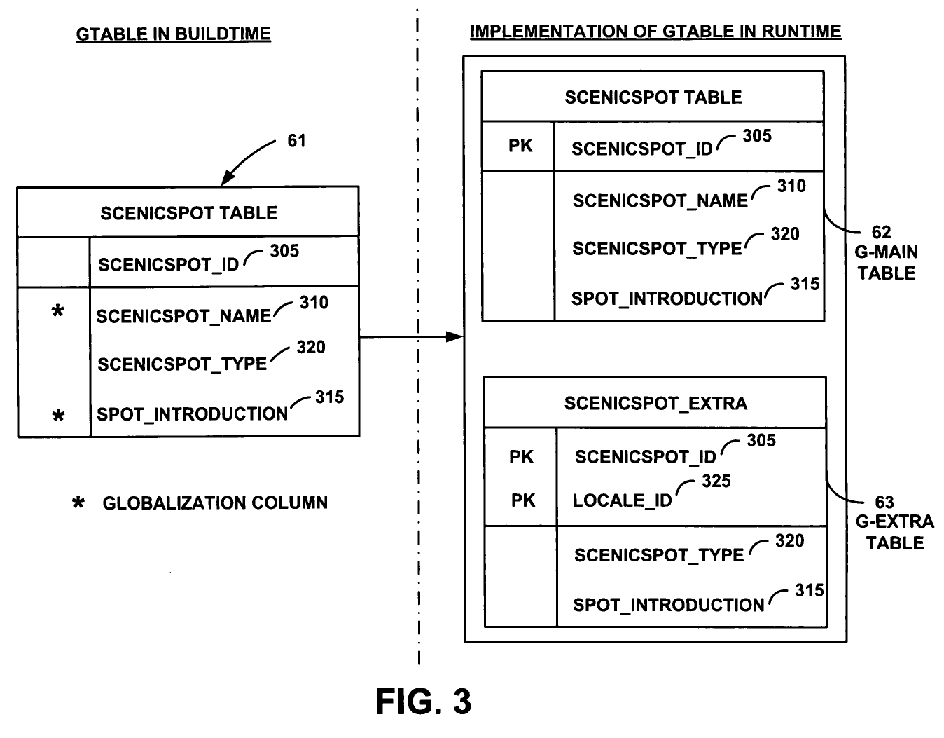

FIG. 3 illustrates an internal structure of the GTable 6. GTable 6 is represented by normal tables in the underlying database, a G-Main table 62, and a G-Extra table 63. The G-Main table 62 comprises the columns that can be accessed by users. The G-Extra table 63 comprises globalized columns. The G-Extra table 63 is hidden to the programmer 92 and can not be accessed directly. The G-Extra table 63 comprises a locale ID (identification) column, which is a foreign key to a system locale table. The G-Main table 62 and the G-Extra table 63 each comprise a default locale, which can be set specifically for a table or inherently from the default locale attribute of the database. GColumns in the G-Main table 62 have values corresponding to the default locale of the G-Main table 62, and the other multilingual data of GColumn are kept in the hidden G-Extra table 63. If the globalization feature of GTable 6 is turned off, operations on the GTable 6 can only affect the values in the G-Main table 62, which correspond to the default locale of the G-Main table 62. A connection between the G-Main table 62 and the G-Extra table 63 is maintained by primary and foreign key pairs.

A table 61 illustrates an internal structure of system 10 under the point of view of a programmer 92 at the build-time for an exemplary core business concern. Table 61 shows an example of a ScenicSpot table 61, whose primary key is a globalized table ID SCENICSPOT_ID 305, and the table comprises globalized columns as SCENICSPOT_NAME 310 and SPOT_INTRODUCTION 315 as well as a non-globalized column SCENICSPOT_TYPE 320. Each of the globalized columns SCENICSPOT_NAME 310 and SPOT_INTRODUCTION 215 has the respective multilingual data corresponding to each locale. For example, when SCENICSPOT_ID 305=1, SCENICSPOT_NAME 310 may be names such as “ [symbol] ” or “west lake” etc., corresponding to various languages.

FIG. 3 further illustrates the structures of the G-Main table 62 and the G-Extra table 63 implementing ScenicSpot table 61 at run-time, wherein the G-Main table 62 contains all the columns of the ScenicSpot table 61, while the G-Extra table 63 comprises the necessary globalized columns (SCENICSPOT_NAME 305 and a SPOT_INTRODUCTION 315 in this case). In addition, besides the primary key SCENICSPOT_ID 305, the G-Extra table 63 also comprises a primary key LOCALE_ID 325 (locale ID) for identifying a locale. The LOCALE_ID 325 is the foreign key of the system locale table, enabling the system locale table to uniquely identify the globalized record corresponding to each locale. That is to say, in the G-Extra table 63, each column in a record uniquely corresponds to a value of the multilingual data. The non-globalized column SCENICSPOT_TYPE 320 does not appear in the G-Extra table 63. As shown in FIG. 3, for the G-Main table 62, SCENICSPOT_ID 305 is also a foreign key of the G-Main table 62. The connection between the G-Main table 62 and the G-Extra table 63 is maintained by the primary key and foreign key pairs formed by their respective primary keys SCENICSPOT_ID 305.

Applications that interact with database management systems typically use the SQL language. The GTable Enhancement layer 21 intercepts the SQL queries that are related to the G-Main table 62 and the G-Extra table 63. The GTable enhancement layer 21 modifies the intercepted SQL query to access the corresponding hidden table, the G-Extra table 63, and also add other locale conditions based on the current thread environment locale. After making modifications (conversions) to the SQL commands, the GTable Enhancement Layer 21 delegates the functions to the underlying driver 22 by passing the modified SQL commands to the driver 22. To the application 93, all these are transparent.

The behavior of the GTable enhancement layer 21 is configured to meet the various existing requirements. In practice, programmer 92 may need both locale sensitive and locale insensitive operations on the GTable 6. Consequently, system 10 provides a switch on the GTable 6 to enable and disable the globalization feature. States of the switch are ON, STRICT-ON, and OFF. In Table 1, the respective behaviors these switch states are described.

TABLE 1
Different behaviors of the GTable

| SWITCH | |
|---|---|
| STATES | BEHAVIOR DESCRIPTIONS |
| ON (default) | In this state, the database access operations are locale |
| | sensitive; the multilingual data in the GColumns are |
| | handled correctly with the current locale. If the GTable |
| | does not have multilingual data of the current locale, select- |
| | ing operations under this locale can obtain a record with |
| | null in its GColumns. |
| STRICT-ON | In this state, the database access operations are locale |
| | sensitive; the multilingual data in the GColumns is handled |
| | correctly with the current locale. If the GTable does not |
| | have multilingual data of the current locale, selecting opera- |
| | tions under this locale obtains no record. |
| OFF | In this state, the database access operations are locale |
| | insensitive; all the database access operations are on the |
| | G-Main table and have no effect on the G-Extra table. |

Providing such a switch allows programmer 92 to customize the GTable enhancement layer 21. For example, when converting an SQL command from a client code, the ON state representing the join type of the FROM clause in the SQL command is left join or right join; the STRICT-ON state representing the join type of the FROM clause in the SQL command is inner join; and the OFF state representing all the operations in the SQL command are only on values corresponding to the default locale in the G-Main table 6.

The switch states can be changed in the run-time via the APIs (Application Programming Interfaces) that system 10 provides. Programmer 92 can also perform locale insensitive operations on the GTable 6. For existing systems, after changing some normal tables to Gtables 6, the programmer 92 may find some operations on some Gtables 6 are still locale insensitive. Consequently, the programmer 92 can add code to close this switch before the database access operation so that the database access operations do not change before and after the application of GTable 6.

The semantics of the SQLs after introducing the GTable 6 and GColumn are the same, while the underlying operations on GColumns change somewhat from the operations on normal columns. A record of GTable 6 may have many possible values in its GColumns. However, after the environment locale is decided, a record of the GTable 6 can be viewed just as a normal record and have an SQL command executed on it. This approach is transparent to the client code, and separates the globalization concern from the core business logic. In one embodiment, configuration files are used to maintain the settings on the database and the GTable 6. These configurations are be used by the GTable enhancement layer 21.

Introduction of system 10 to a database system has little impact on performance of the database system. Metadata of the GTable 6 are installed at the beginning. For Gtable 6, operations that were previously handled by the programmer 92 are now handled by the GTable enhancement layer 21: when involving the GColumns, to execute SQL conversion and delegate to the underlying driver 22; and when not involving the GColumns, to directly delegate to the underlying driver 22. Operations on database table 7 are just delegated to the underlying driver 22 without any notable impact on performance. Therefore, introducing system 10 only introduces some checking and SQL transformation works, which does not have great impact on performance.

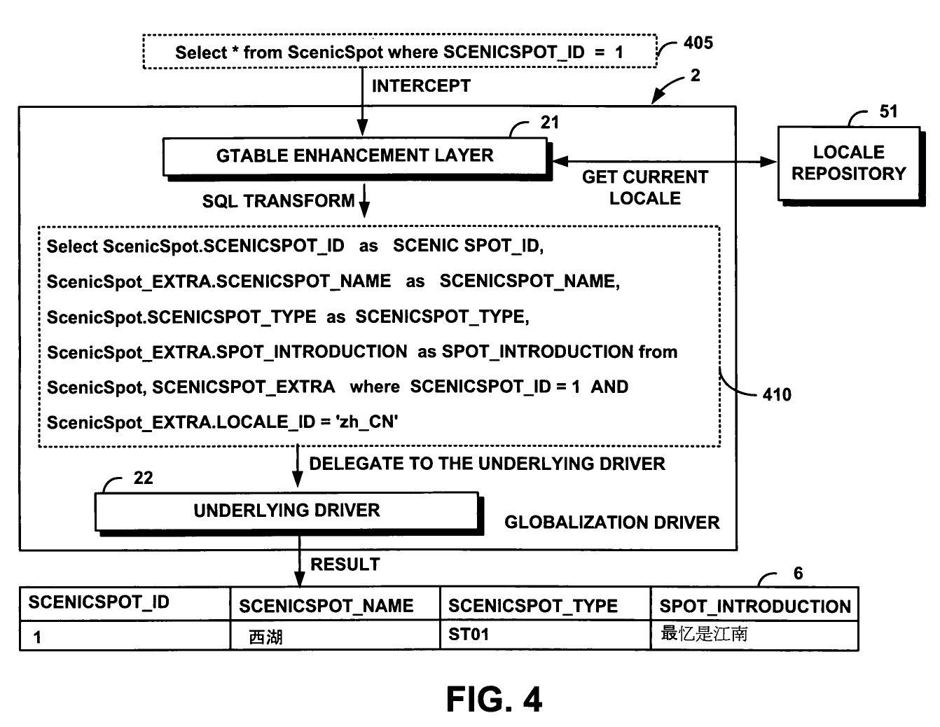

FIG. 4 illustrates an exemplary implementation of system 10 based on the tables shown in FIG. 3. A specific application 93 requests access to the globalized database table to query the multilingual data. The specific application 93 comprises SQL query commands in the access codes to perform the query, such as the SQL statement 405 in FIG. 4:
Select*from ScenicSpot where SCENICSPOT_ID=1
   The globalization driver 2 intercepts the SQL statement through its GTable enhancement layer 21 to prepare for the transformation of the SQL statement.

The GTable enhancement layer 21 retrieves the current locale from a locale repository 51 and transforms the SQL statement 405 into a transformed SQL statement 410:
Select ScenicSpot.SCENICSPOT_ID as SCENICSPOT_ID,
ScenicSpot_EXTRA.SCENICSPOT_NAME as SCENICSPOT_NAME,
ScenicSpot.SCENICSPOT_TYPE as SCENICSPOT_TYPE,
ScenicSpot_EXTRA.SPOT_INTRODUCTION as SPOT_INTRODUCTION from ScenicSpot, ScenicSpot_EXTRA where SCENICSPOT_ID=1 AND
ScenicSpot_EXTRA.LOCALE_ID=‘zh_CN’
   where the current locale zh_CN has been incorporated in the transformed SQL statement 410. The GTable enhancement layer 21 delegates the transformed SQL statement 410 to the underlying driver 22 which accesses the underlying database. The underlying driver 22 retrieves a query result in the form of a GTable 6 based on the G-Main table 62 and the G-Extra table 63. The non-globalized data SCENICSPOT_TYPE=ST101 with SCENICSPOT_ID=1 is retrieved from the G-Main table 62, the globalized data SCENICSPOT_NAME= [symbol] and SPOT_INTRODUCTION= [symbol] with SCENICSPOT_ID=1 are retrieved from the G-Extra table 63 according to the locale LOCALE_ID=zh_CN in the G-Extra table 63.

The internal structure of the GTable 6 shown in FIG. 3 is only an example of an embodiment of system 10, and other forms can also be adopted to implement the GTable 6 of system 10. For example, in FIG. 3, the structure of the G-Main table 62 is retained, while additional views are established to maintain the multilingual data, wherein one kind of language corresponds to one view. The views are established through querying the G-Main table 62, and maintain the DB schema equivalent to that of the G-Main table 62.

In one embodiment, the GTable 6 can adopt a structure column, in which a data structure is maintained to replace the simple data type. The structure column can be used to maintain all multilingual information in one column, such that only the G-Main table 62 is used to support the GTable 6 without needing an additional extra table.

The locale model provided by system 10 provides transparent support of GTable 6 and designs the locale as an environment attribute instead of an interface parameter of a function. In the build-time, system 10 introduces a system locale table for managing the supported locales in the database. A management tool handles these locale settings. A default locale attribute is associated with a database and a table. A default locale of a table can be inherited from the default locale of the database if the default locale of the table is not set specifically. The default locale of the table determines which locale sensitive values are stored in the GColumns of the G-Main table 62.

The run-time locale model library 5 enables the programmer 92 to register/retrieve the current locale and mark the call level (change the switch state that is introduced in Table 1). This run-time locale model library 5 can use different technologies to implement the defined common interfaces in various environments. The programmer 92 can customize application 93 to implement the given interface. The interfaces comprise the following:
Register the locale,
Mark the call level (optional), and
Retrieve the locale.

In a typical process, programmer 92 calls the “register the locale” interface after receiving a request from the user. The GTable enhancement layer 21 invokes the ‘retrieve the locale’ interface to automatically obtain the run-time locale. All of the existing code of the user need not be changed to transfer the locale information. The ‘mark the call level’ interface is optional for programmer 92 to adjust the switch state in Table 1 of the introduced GTable 6 according to the practical need of an application. For example, as described above, some operations of the GTables 6 in some specific applications 93 may still be locale insensitive, so some codes can be added to turn off the switch (OFF) of the GTable 6 before the database accessing operations, allowing the accessing operations of the specific database to have no impact on the G-Extra table 63.

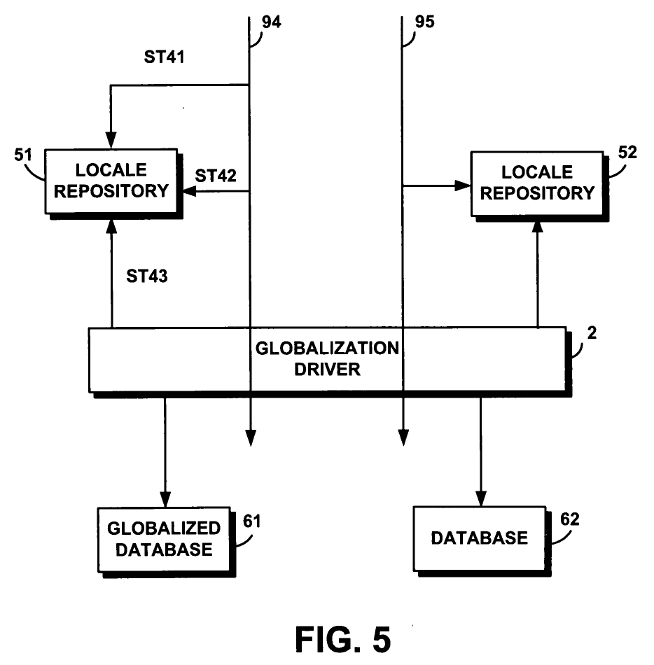

FIG. 5 describes a build-time locale model 4 in an exemplary single JVM (Java Virtual Machine) environment. In a single machine application environment, the codes of the application 93 use the run-time locale repository 51 to set the environment locale at some proper time. If no locale is defined for a thread, then the default locale of the application 93 is used. The locale information is put in the thread local storage, so it is guaranteed that the globalization driver 2 will obtain the same locale identification as the registered one.

For example, in FIG. 5, in a single JVM, a thread 94 of application 93 comprises a query command for the globalized database 61. The thread 94 retrieves a locale setting of a user, and at ST41 invokes the ‘register the locale’ interface to put into the thread local storage, i.e. the locale repository 51, information related to the locale of the user (locale handle or locale ID). The globalization driver 2 invokes the ‘retrieve the locale’ interface at ST43 to automatically extract the information and incorporates the information into a database query (SQL command) of thread 94, i.e. into the SQL command transformed by globalization driver 2, so as to retrieve a required globalized data value corresponding to the locale ID from the underlying database 61.

A thread 95 in FIG. 5 performs the same process as that of thread 94, except that it uses the thread local storage of the thread 95 itself, i.e. locale repository 52, and retrieves the required globalized data values from the underlying database 62. As can be seen from FIG. 5, locale repository 51 and locale repository 52 are thread local storage of thread 94 and thread 95, respectively. The locale repository 51 and the locale repository 52 are separated from each other i.e., the locale repository 51 and the locale repository 52 are a kind of logic repository concept.

As described above, the globalized database 61 and the database 62 in FIG. 5 are not limited to the separated databases, but can exist in a same database. The invoking of the “mark the call level” interface as shown at ST42 in FIG. 5 is optional, the function of which is storing in locale repository 51 or locale repository 52 as thread local storage the above-mentioned switch state customized for the GTable enhancement layer 21 as a configuration parameter. The globalization driver 2, when invoking the “retrieve the locale” interface at ST43, automatically extracts switch state parameter information and incorporates the switch state parameter information into the SQL command transformed by globalization driver 2.

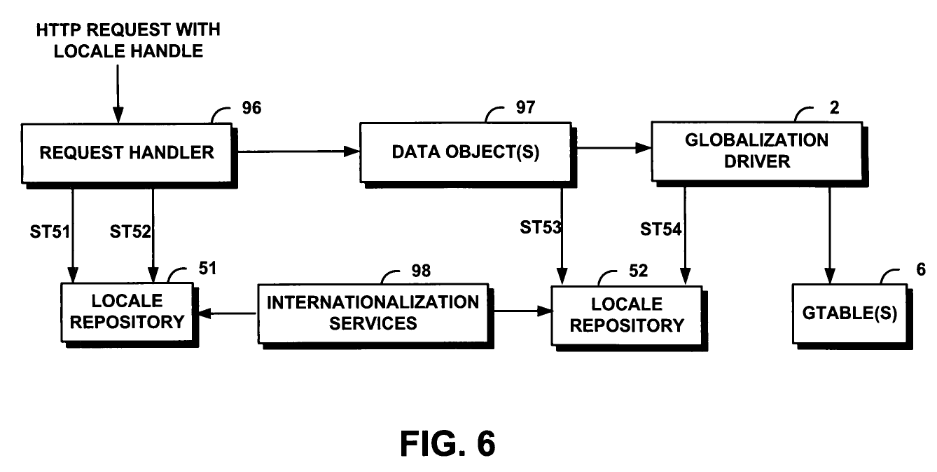

For a distributed environment, a different implementation of the run-time locale model is required. For instance, FIG. 6 describes an exemplary run-time locale model in a distributed environment. The environment shown in FIG. 6 is WebSphere Application Server V5 Enterprise Edition (WAS V5 for short). Thus the programmer 92 only needs to register the locale value at a proper time regardless of a complicated system structure. While system 10 is described for illustration purpose only in terms of WAS V5 or WAS, it should be clear that system 10 is applicable as well to, for example, any web-based application server.

Referring to FIG. 6, the request handler 96 using WAS V5 and the data object(s) 97 using WAS V5 are separated from each other in a distributed environment. The request handler 96 handles a request from a user, especially a request for querying the globalized data. The request handler 96 invokes a remote EJB (Enterprise Java Beans) regardless of the globalized feature, i.e., without a locale handle. The remote EJB drives the data object 97 to implement database access that is delegated to a local globalization driver 2.

The request handler 96 retrieves the locale setting (locale ID) of a user from the request of the user such as an HTTP (Hypertext Transfer Protocol) request with a locale handle, and invokes the “register the locale” interface at ST51 to place the information related to the locale of the user (locale handle or ID) into the locale repository 51. Internationalization service(s) 98 of the WAS V5 can automatically synchronize the local locale repository 51 of the request handler 96 with the local locale repository 52 of data object(s) 97 (e.g., the globalization driver 2 coupled directly to the data object 97). This enables the globalization driver 2, at ST54, to invoke the “retrieve the locale” interface, automatically extract the locale ID registered at ST51, and incorporate the locale ID into a database query (SQL command) of an application, i.e. contain it in an SQL command converted by the globalization driver 2. The globalization driver 2 thereby retrieves a globalized data value corresponding to the locale ID from the underlying GTable 6.

The invoking of the “mark the call level” interface shown in ST52 and ST53 in FIG. 6 is optional, the function of which is to store above-mentioned switch states into the locale repository 51 or the locale repository 52 as configuration parameters. The globalization driver 2, when invoking the “retrieve the locale” interface at ST54, automatically extracts the switch state parameter information and incorporates the switch state parameter information into the SQL command converted by the globalization driver 2.

A GTable manager 3 shown in FIG. 2 provides a GTable management tool for data designer 92. The GTable manager 3 further maintains the consistency of GTable metadata between build-time and run-time. The GTable metadata may be stored in file systems or databases so that the run-time globalization driver 2 can retrieve these metadata to manage the SQL transformation. The GTable metadata comprise, for example, a table name list of GTable, a name list of GColumn and a list of relation between GTable and GColumn.

The GTable manager 3 comprises the following functions:
a) Change a normal table to the GTable type and vice versa;
b) Change a normal column to the GColumn type and vice versa;
c) Manage the build-time supported locales in the database, which is performed by manipulating the system locale table;
d) Set default locale for the database and the Gtables; and
e) Assist import and export of the multi-lingual data of the GTables.

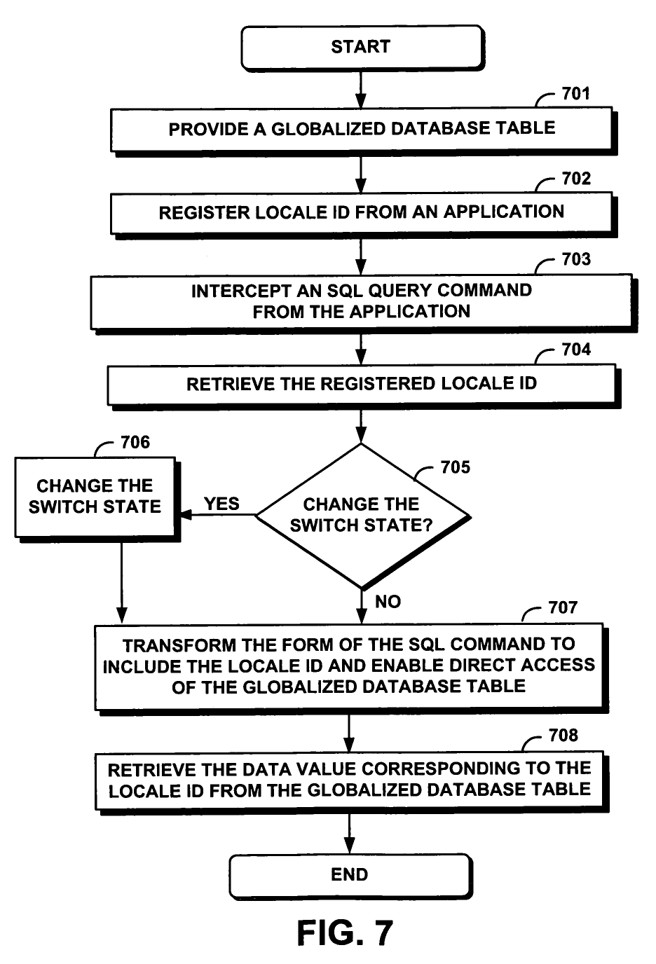

FIG. 7 illustrates a method of system 10 in accessing a globalized database. At step 701, a globalized database table is provided in the globalized database. The structure of the globalized database comprises a G-Main table 62 and a G-Extra table 61 as shown in FIG. 3. At step 702, an application registers a locale ID of the application at a proper time (typically at the beginning). The registering process can adopt the proper modes for different application environments as shown in FIG. 5 or FIG. 6.

At step 703, the globalization driver 2 intercepts the data query command (SQL command) from the application. At step 704, the globalization driver 2 retrieves the locale ID registered by the application by using the proper modes for different application environments as shown in FIG. 5 or FIG. 6. At step 705, the application may select whether to change the switch state of the GTable. If selecting to change the switch state of the GTable (Yes) at step 705, then the switch state parameter is transferred to the globalization driver 2 at step 706, and the detailed transferring mode can adopt the mode described in the description of FIG. 5 or FIG. 6.

If selecting not to change the switch state of the GTable (No) at step 705 or after completing the step 706, the flow proceeds to the main flow, i.e., step 707. Step 705 and step 706 are shown after step 704 in FIG. 7, but they can also be before step 704 and concurrent with registering a locale ID at step 702. In this case, at this time the flow proceeds to step 703 after completing step 706. That is to say, the proper locations of step 705 and step 706 can be selected according to a specific application.

At step 707, the globalization driver 2 transforms the SQL command in the application to a form capable of direct access of the globalized database table, i.e., the G-Main table 62 and the G-Extra table 63. The transformed SQL command comprises the locale ID registered by the application (retrieved at step 704) and the switch state parameter transferred at step 706. At step 708, through the transformed SQL command, the values of the locale sensitive data corresponding to the registered locale IDs are retrieved from the globalized columns of the G-Main table 62 and the G-Extra table 63. Then the flow ends.

It is to be understood that the specific embodiments of the invention that have been described are merely illustrative of certain applications of the principle of system 10. Numerous modifications may be made to the globalized database and methods of accessing the same described herein without departing from the spirit and scope of the present invention.

What is claimed is:

1. A method of accessing a globalized database, comprising:
providing a globalized database table in the globalized database, wherein the globalized database includes a plurality of globalized columns corresponding to a user query, and wherein each of the globalized columns comprises a plurality of data values that correspond to different locales;
receiving a database query command from the user;
retrieving a user's locale identification; and
based on the retrieved user's locale identification, retrieving a locale sensitive data value, corresponding to the user's locale identification, from the globalized columns in the globalized database table.

2. The method according to claim 1, wherein the globalized database table comprises:
a first table including a globalized database table identification column, a globalized column, and a non-globalized column, wherein the globalized database table identification column includes primary keys of the first table; and
a second table including a globalized database table identification column, a locale identification column, and a globalized column, in which the globalized database table identification column and the locale identification column include primary keys of the second table, and the globalized database table identification column includes a foreign key of the first table.

3. The method according to claim 2, wherein the locale identification column comprises a default locale identification so that each globalized column in the first table takes a locale sensitive data value corresponding to the default locale identification.

4. The method according to claim 1, wherein the globalized database table includes a globalized database table identification column, a globalized column, and a non-globalized column;
wherein the globalized database table identification column includes a primary key of the globalized database table; and
wherein the database further includes a plurality of views, wherein each view corresponds to one locale identification and maintains the same database schema as that of the globalized database table.

5. The method according to claim 1, wherein the globalized database table includes a globalized database table identification column, a globalized column, and a non-globalized column; and
wherein the globalized database table identification column includes a primary key of the globalized database table.

6. The method of claim 5, wherein the globalized column adopts structural column for maintaining a data structure, to maintain a plurality of data values related to various locales in one globalized column.

7. The method according to claim 1, further comprising converting the query command query command into a form that is capable of accessing the globalized database table in combination with the user's locale identification, after retrieving the user's locale identification.

8. The method according to claim 1, further comprising before intercepting the user's data query command, registering a locale identification of the user, wherein the locale identification obtained by retrieving the user's locale identification includes the registered locale identification.

9. The method according to claim 8, wherein the steps of registering the locale identification and retrieving the registered locale identification are applicable for any of a single machine application environment or a distributed application environment.

10. The method according to claim 2, further comprising adjusting an operational state for accessing the globalized column into one of the following states:
a first state in which the access operation is locale sensitive, and if the globalized database table does not have a data value corresponding to the current locale identification, the value retrieved by the operation accessing the globalized column under the locale identification is a null record;
a second state in which the access operation is locale sensitive, and if the globalized database table does not have a data value corresponding to the current locale identification, no record is retrievable by the operation accessing the globalized column under the locale identification; and
a third state in which the access operation is locale insensitive and is only performed on the first table without any impact on the second table.

11. A computer program product having a plurality of executable instruction codes that are stored on a computer-readable medium, for accessing a globalized database, comprising:
a first set of instruction codes for providing a globalized database table in the globalized database, wherein the globalized database includes a plurality of globalized columns corresponding to a user query, and wherein each of the globalized columns comprises a plurality of data values that correspond to different locales;
a second set of instruction codes for receiving a database query command from the user;
a third set of instruction codes for retrieving a user's locale identification; and
a fourth set of instruction codes for locale retrieving a locale sensitive data value, corresponding to the user's locale identification, from the globalized columns in the globalized database table, based on the retrieved user's locale identification.

12. The computer program product according to claim 11, wherein the globalized database table comprises:
a first table including a globalized database table identification column, a globalized column, and a non-globalized column, wherein the globalized database table identification column includes primary keys of the first table; and
a second table including a globalized database table identification column, a locale identification column, and a globalized column, in which the globalized database table identification column and the locale identification column include primary keys of the second table, and the globalized database table identification column includes a foreign key of the first table.

13. The computer program product according to claim 12, wherein the locale identification column comprises a default locale identification so that each globalized column in the first table takes a locale sensitive data value corresponding to the default locale identification.

14. The computer program product according to claim 11, wherein the globalized database table includes a globalized database table identification column, a globalized column, and a non-globalized column;
wherein the globalized database table identification column includes a primary key of the globalized database table; and
wherein the database further includes a plurality of views, wherein each view corresponds to one locale identification and maintains the same database schema as that of the globalized database table.

15. The computer program product according to claim 11, wherein the globalized database table includes a globalized database table identification column, a globalized column, and a non-globalized column;
wherein the globalized database table identification column includes a primary key of the globalized database table;
wherein the globalized column adopts structural column for maintaining a data structure, to maintain a plurality of data values related to various locales in one globalized column.

16. A globalized database system, comprising:
an input means for inputting normal data that form part of the globalized database; and
a globalized database table generating means for extracting locale related data from the input normal data, to generate a globalized database table that includes a plurality of globalized columns, and to place a plurality of data values of the same kind corresponding to different locales into one globalized column for later database query.

17. The globalized database system according to claim 16, wherein the globalized database table comprises:
a first table including a globalized database table identification column, a globalized column, and a non-globalized column, wherein the globalized database table identification column includes primary keys of the first table; and
a second table including a globalized database table identification column, a locale identification column, and a globalized column, in which the globalized database table identification column and the locale identification column include primary keys of the second table, and the globalized database table identification column includes a foreign key of the first table.

18. The globalized database system according to claim 17, wherein the locale identification column includes a default locale identification so that each globalized column in the first table takes a locale sensitive data value corresponding to the default locale identification.

19. The globalized database system according to claim 16, wherein the globalized database table includes a globalized database table identification column, a globalized column and a non-globalized column, wherein the globalized database table identification column includes a primary key of the globalized database table;
wherein the database further includes a view; and
wherein each view corresponding to one locale identification maintains a same database schema as that of the globalized database table.

20. The globalized database system according to claim 16, wherein the globalized database table includes a globalized database table identification column, a globalized column and a non-globalized column;
wherein the globalized database table identification column includes a primary key of the globalized database table; and
wherein the globalized column adopts structural column for maintaining a data structure, to maintain a plurality of data values related to various locales in one column.

21. A globalized database system, comprising:
a locale determining driver for determining a locale identification from a user's application;
a database for storing a globalized database table that includes at least a globalized column corresponding to a user query, wherein the globalized column includes a plurality of data values related to different locales; and
a database access driver for intercepting a database query command of the user, and based on the locale identification retrieved from the locale determining driver, retrieving the locale related data value, corresponding to the locale identification, from the globalized column in the globalized database table.
